(19) United States
(12) Patent Application Publication
(10) Pub. No.: US 2007/0121751 A1
(43) Pub. Date: May 31, 2007

(54) Methods and apparatus for beamforming training symbols in wireless multiple-input-multiple-output systems

(76) Inventors: Qinghua Li, Sunnyvale, CA (US); Xintian E. Lin, Mountain View, CA (US)

Correspondence Address: INTEL CORPORATION;C/O INTELLEVATE, LLC, P.O. BOX 52050, MINNEAPOLIS, MN, 55402, US

(21) Appl. No.: 11/150,779

(22) Filed: Jun. 9, 2005

(51) Int. Cl. H04B 7/02

(52) U.S. Cl. 375/267

(57) ABSTRACT

Embodiments of methods and apparatus for beamforming training symbols in wireless multiple-input-multiple-output systems are generally described herein. Other embodiments may be described and claimed.

### TECHNICAL FIELD

The present disclosure relates generally to wireless communication systems, and more particularly, to methods and apparatus for beamforming training symbols in wireless multiple-input-multiple-output (MIMO) systems.

### BACKGROUND

A data frame of a wireless MIMO system may include one or more training symbols such as preamble symbols, pilot symbols, and/or midamble symbols. In general, a preamble symbol may be a training symbol at the beginning of each data frame. Typically, the preamble symbol may be used for various synchronization tasks. A pilot symbol may be a training symbol to provide tracking information, which may be associated with a spatial channel. A midamble symbol may be a training symbol corresponding to a time slot (e.g., at the beginning of a user zone). To increase data throughput in wireless MIMO systems, some development efforts have been directed toward improving channel estimation for beamformed spatial channels and reducing pilot allocation.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example base station.

FIG. 3 is a block diagram representation of an example wireless MIMO system.

FIG. 4 is a flow diagram representation of one manner in which the example base station of FIG. 2 may be configured to beamform training symbols.

FIG. 5 is a block diagram representation of an example processor system that may be used to implement the example base station of FIG. 2.

### DETAILED DESCRIPTION

In general, methods and apparatus for beamforming training symbols in wireless multiple-input-multiple output (MIMO) systems are described herein. The methods and apparatus described herein are not limited in this regard.

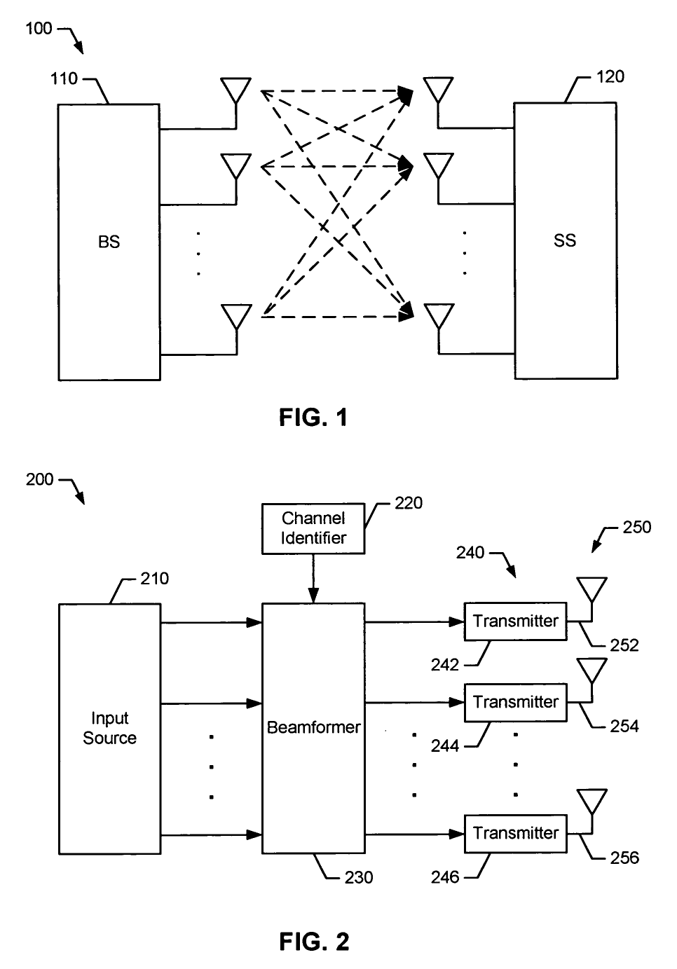

Referring to FIG. 1, an example wireless communication system 100 including a base station (BS) 110 and a subscriber station (SS) 120 is described herein. Although FIG. 1 may depict one base station, the wireless communication system 100 may include additional base stations. In a similar manner, the wireless communication system 100 may include additional subscriber stations even though FIG. 1 depicts one subscriber station.

The base station 110 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate via wireless links. For example, the base station 110 may implement OFDM modulation to transmit large amounts of digital data by splitting a radio frequency signal into multiple small sub-signals, which in turn, are transmitted simultaneously at different frequencies. In particular, the base station 110 may use OFDM modulation as described in the 802.xx family of standards developed by the Institute of Electrical and Electronic Engineers (IEEE) and/or variations and evolutions of these standards (e.g., 802.11, 802.15, 802.16, etc.) to communicate with the subscriber station 120. In addition or alternatively, the base station 110 may operate in accordance with other suitable wireless communication protocols that require very low power such as Bluetooth, Ultra Wideband (UWB), and/or radio frequency identification (RFID) to communicate with the subscriber station 120.

The base station 110 may also operate in accordance with other wireless communication protocols may be based on analog, digital, and/or dual-mode communication system standards. For example, the base station 110 may operate in accordance with wireless communication protocols such as orthogonal frequency division multiple access (OFDMA)-based standards, time division multiple access (TDMA)-based standards (e.g., Global System for Mobile Communications (GSM), General Packet Radio Services (GPRS), Enhanced Data GSM Environment (EDGE), Universal Mobile Telecommunications System (UMTS), etc.), code division multiple access (CDMA)-based standards, wideband CDMA (WCDMA)-based standards, variations and evolutions of these standards, and/or other suitable wireless communication standards.

The subscriber station 120 may be a laptop computer, a handheld computer, a tablet computer, a cellular telephone (e.g., a smart phone), a pager, an audio and/or video player (e.g., an MP3 player or a DVD player), a game device, a digital camera, a navigation device (e.g., a GPS device), and/or other suitable wireless electronic devices. The subscriber station 120 may communicate via wireless links as described in the 802.xx family of standards developed by the Institute of Electrical and Electronic Engineers (IEEE) and/or variations and evolutions of these standards (e.g., 802.11, 802.15, 802.16, etc.). In one example, the subscriber station 120 may operate in accordance with the 802.16 family of standards developed by IEEE to provide for fixed, portable, and/or mobile broadband wireless access (BWA) networks (e.g., the IEEE std. 802.16, published 2004). The subscriber station 120 may also use direct sequence spread spectrum (DSSS) modulation (e.g., the IEEE std. 802.11b) and/or frequency hopping spread spectrum (FHSS) modulation (e.g., the IEEE std. 802.11). Further, the subscriber station 120 may also operate in accordance with other suitable wireless communication protocols that require very low power such as Bluetooth, Ultra Wideband (UWB), and/or radio frequency identification (RFID) to communicate via wireless links. In addition or alternatively, the subscriber station 120 may communicate via wired links (not shown). For example, the subscriber stations 120 may use a serial interface, a parallel interface, a small computer system interface (SCSI), an Ethernet interface, a universal serial bus (USB) interface, a high performance serial bus interface (e.g., IEEE 1394 interface), and/or any other suitable type of wired interface to communicate. The methods and apparatus described herein are not limited in this regard.

Further, the wireless communication system 100 may include other wireless personal area network (WPAN) devices, wireless local area network (WLAN) devices, wireless metropolitan area network (WMAN) devices, and/or wireless wide area network (WWAN) devices such as network interface devices and peripherals (e.g., network interface cards (NICs)), access points (APs), gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system (not shown). Accordingly, the wireless mesh network 110 may be implemented to provide WPANs, WLANs, WMANs, WWANs, and/or other suitable wireless communication networks. Although certain examples have been described above, the scope of coverage of this disclosure is not limited thereto.

In the example of FIG. 2, a base station 200 may include an input source 210, a channel identifier 220, and a beamformer 230. The beamformer 230 may be coupled to the input source 210 and the channel identifier 220. The input source 210 may provide one or more data streams to the beamformer 230. For example, a data stream may include a portion of a data frame. In another example, a data stream may include one or more data frames. Each frame may include one or more training symbols. In particular, a training symbol may be a preamble symbol, a pilot symbol, and/or a midamble symbol.

In general, a preamble symbol may be a training symbol located at the beginning of each frame and used for various synchronization tasks. A pilot symbol may be a training symbol to provide information for channel tracking and estimation, which may be associated with a transmit antenna and/or a spatial channel. A midamble symbol may be a training symbol corresponding to a time slot (e.g., at the beginning of a user zone). A user may carry and/or operate a subscriber station (e.g., SS 120 of FIG. 1), and a user zone may be a set of subcarriers and a set of time slots within an OFDMA frame associated with the subscriber station. For example, the pilot and midamble symbols may be used to enhance channel estimation in broadband channels for a particular user.

The channel identifier 220 may identify a plurality of spatial channels available to the base station 200. The plurality of spatial channels may be shared by two or more subscriber stations (e.g., one shown as 120 in FIG. 1). For example, the plurality of spatial channels may be assigned to two or more subscriber stations with each subscriber station including one receiver with multiple active receive antennas (e.g., point-to-point MIMO), multiple receivers with each receiver having an active receive antenna (e.g., point-to-multiple-point MIMO), or a combination thereof.

As described in detail below, the beamformer 230 may compute beamforming weights associated with each of the plurality of spatial channels identified by the channel identifier 220 to beamform pilots associated with the data streams from the input source 210. The base station 200 may also include a plurality of transmitters 240, generally shown as 242, 244, and 246, and a plurality of antennas 250, generally shown as 252, 254, and 256. The plurality of transmitters 240 may be coupled to the beamformer 230. Each of the plurality of transmitters 240 may be coupled to one of the plurality of antennas 250. For example, the transmitter 242 may be coupled to the antenna 252, the transmitter 244 may be coupled to the antenna 254, and the transmitter 246 may be coupled to the antenna 256. Although FIG. 2 depicts three transmitters, the base station 200 may include additional or fewer transmitters. In a similar manner, the base station 200 may include additional or fewer antennas even though FIG. 2 depicts three antennas. The methods and apparatus described herein are not limited in this regard.

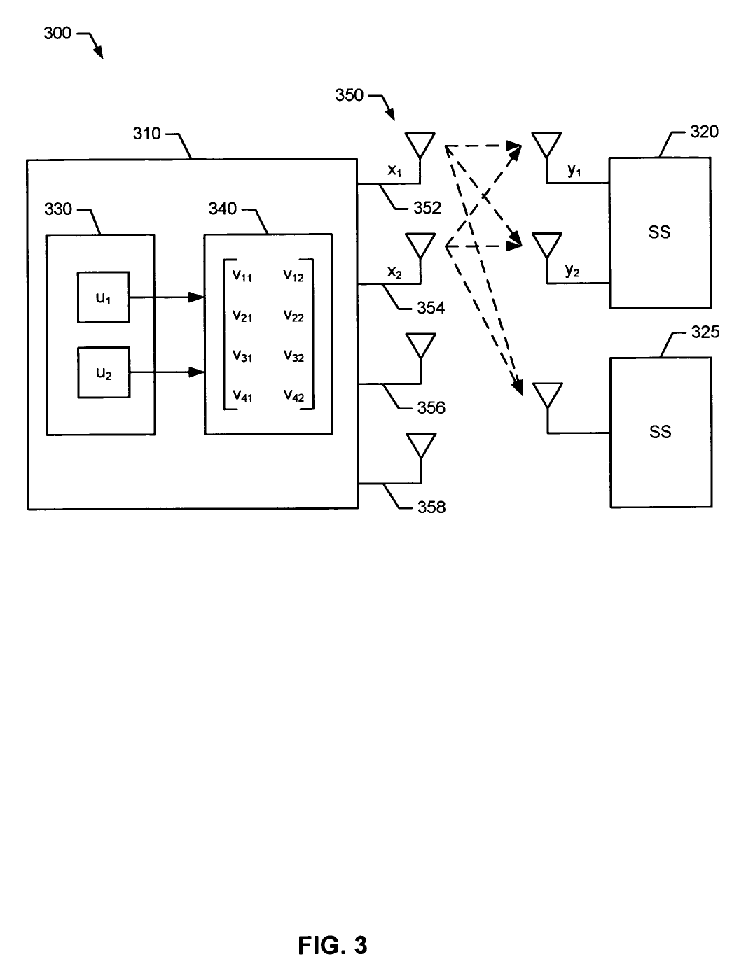

Referring to FIG. 3, an example wireless MIMO system 300 may include a base station 310 and one or more subscriber stations, generally shown as 320 and 325. The wireless MIMO system 300 may include a point-to-point MIMO system and/or a point-to-multiple point MIMO system. For example, a point-to-point MIMO system may include the base station 310 and the subscriber station 320. A point-to-multiple point MIMO system may include the base station 310 and the subscriber station 325. The base station 310 may transmit data streams to the subscriber stations 320, 325 simultaneously. For example, the base station 310 may transmit two data streams to the subscriber station 320 and one data stream to the subscriber station 325. Although FIG. 1 may depict two subscriber stations, the wireless MIMO system 300 may include additional or fewer subscriber stations.

The base station 310 may include an input source 330 and a beamformer 340. The base station 310 may transmit two data streams from the input source 330 through two beamformed spatial channels over four transmit antennas 350, generally shown as 352, 354, 356, and 358. Although FIG. 3 depicts four transmit antennas, the base station 310 may include additional or fewer transmit antennas.

The input source 310 may provide a data/pilot symbol vector u. The data/pilot symbol vector u may be represented as

$$u = [ \begin{matrix}{u}_{1} \\ {u}_{2}\end{matrix} ] ,$$

where u₁ may be transmitted through a first spatial channel and u₂ may be transmitted through a second spatial channel. The first and second spatial channels may be assigned to the subscriber station 320 including one receiver with multiple receive antennas (e.g., point-to-point MIMO).

To beamform the pilots of the two data streams, the beamformer 330 may determine a beamforming weight for each transmit antenna/spatial channel pair. In one example, the base station 300 may include eight transmit antenna/spatial channel pairs to correspond to the four transmit antennas and the two spatial channels. In particular, the beamformer 330 may use a beamforming matrix V based on the number of transmit antennas and the number of spatial channels of the base station 300. Accordingly, the beamforming matrix V may be represented by a 4×2 matrix as

$$V = [ \begin{matrix}{v}_{11} & {v}_{12} \\ {v}_{21} & {v}_{22} \\ {v}_{31} & {v}_{32} \\ {v}_{41} & {v}_{42}\end{matrix} ] ,$$

where vᵢⱼ is the complex weight for the j-th channel on i-th antenna. For example, v₁₁ may represent the beamforming weight for the first spatial channel on the antenna 352 while v₄₂ may represent the beamforming weight for the second spatial channel on the antenna 358. In a similar manner, v₄₁ may represent the beamforming weight for the first spatial channel on the antenna 358 while v₁₂ may represent the beamforming weight for the second spatial channel on the antenna 352.

The base station 310 may transmit a signal vector x to the subscriber station 320 via the plurality of transmit antennas 350. The signal vector x may be represented as x=Vu, where V is the beamforming matrix and u is the data/pilot symbol vector. In one example, the antenna 352 may transmit x₁ and the antenna 354 may transmit x₂ of the signal vector x.

As indicated above, the base station 310 may transmit pilots via four spatial channels because the four transmit antennas may form the four spatial channels. Although the base station 310 may employ up to four spatial channels, the base station 310 may transmit pilots over two spatial channels formed by the four transmit antennas because the subscriber station 320 may receive at most two spatial streams with only two receive antennas. Accordingly, the beamforming matrix V may be represented by an M=N matrix to avoid redundancy, where M is the number of transmit antennas employed and N is the number of active spatial channels. In particular, active spatial channels may be spatial channels carrying data and used by the subscriber station 320 to receive data streams from the base station 310 via receive antennas. The base station 310 may release bandwidth allocated for pilots of inactive spatial channels. Thus, the base station 310 may increase data throughput by transmitting a greater amount of data with the released bandwidth.

By transmitting training symbols (e.g., pilot or midamble) via one antenna in a non-beamformed manner, for example, other antennas may not transmit data symbols because the data symbols may interfere with the training symbols. As a result, dedicated time slots may need to be reserved to transmit training symbols of a non-beamformed environment. In contrast, training symbols and data symbols of a beamformed environment may be transmitted simultaneously (e.g., during the same time slot) or concurrently (e.g., overlapping the same time slot) via distinct beamformed spatial channels without interference.

To avoid using additional bandwidth for transmitting information associated with the spatial channels, the base station 300 may beamform training symbols (e.g., pilots and/or midambles) so that the subscriber station 320 may identify the beamformed spatial channels to retrieve data from the base station 310 (e.g., coherent detection). In particular, the beamformed spatial channels may be the product of two matrices. The beamformed spatial channels may be represented as

$$Y = [ \begin{matrix}{y}_{1} \\ {y}_{2}\end{matrix} ] = HV ,$$

where H is the channel matrix and V is the beamforming matrix. Accordingly, the subscriber station 320 may determine the beamformed channels Y to retrieve beamformed data transmitted from the base station 310. Otherwise without beamformed training symbols, the subscriber station 320 may only estimate the channel matrix H using training symbols transmitted by the antennas without beamforming, and the base station 310 may be required to use additional bandwidth to transmit the beamforming matrix V to the subscriber station 320. The methods and apparatus described herein are not limited in this regard.

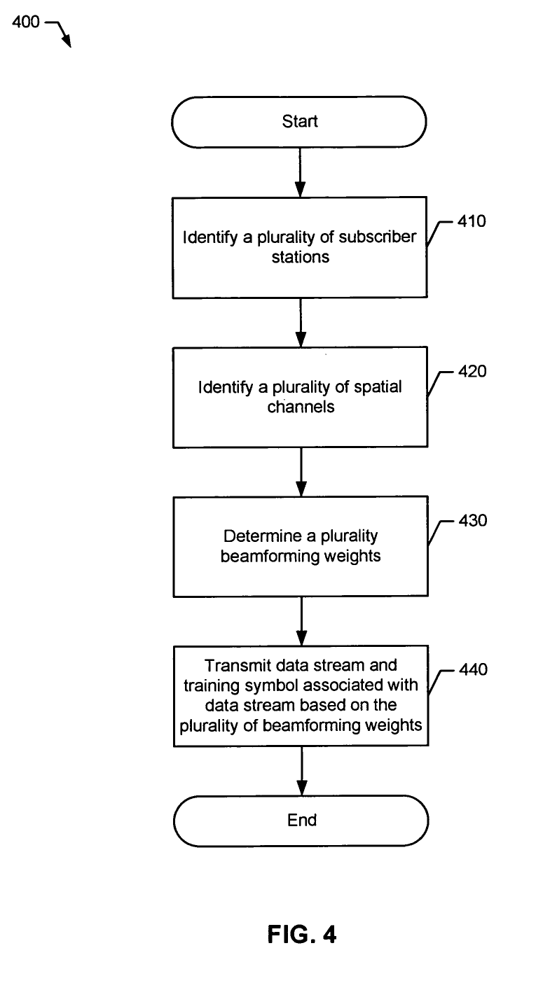

FIG. 4 depicts one manner in which the example base stations of FIGS. 2 and 3 may be configured to beamform training symbols in wireless MIMO systems. The example process 400 of FIG. 4 may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium.

Further, although a particular order of actions is illustrated in FIG. 4, these actions can be performed in other temporal sequences. Again, the example process 400 is merely provided and described in conjunction with the apparatus of FIGS. 2 and 3 as an example of one way to configure a base station to beamform training symbols in wireless MIMO systems.

In the example of FIG. 4, the process 400 may begin with the base station 310 (FIG. 3) identifying a plurality of subscriber stations that share a plurality of spatial channels (e.g., the subscriber station 320 of FIG. 3) (block 410). The base station 310 may select the subscriber station based on separation of spatial channels and/or traffic schedules. In one example, the spatial signatures of two adjacent subscriber stations may be identical or relatively similar. To differentiate between subscriber stations, the base station 310 may select subscriber stations with different spatial signatures.

In another example, a change in beamforming weights during a burst of transmission to two subscriber stations may compensate for one of the subscriber stations receiving the transmission from the base station 310 earlier than the other subscriber station. However, the change in beamforming weights may cause an interruption of the channel status, which is an undesirable effect on the subscriber stations. Thus, the base station 310 may select subscriber stations with identical or relatively similar duration of transmission. Alternatively, the base station may continue to use the beamformed weights for spatial channels of any remaining subscriber stations to avoid the interruption. Further, the base station may change the beamformed weights used by the finished subscriber stations so that data may be transmitted to new subscriber stations through the new beamformed spatial channels.

The base station 310 (e.g., via the channel identifier 220 of FIG. 2) may identify the plurality of spatial channels used by the subscriber station 320 (block 420). In particular, the base station 310 may identify a number of spatial channels based on a number of transmit antennas associated with the base station 310 and a number of receive antennas associated with the subscriber station 320. In a point-to-point MIMO wireless system, for example, the subscriber station 320 (FIG. 3) may include a single receiver with a plurality of antennas. In another example, a point-to-multiple-point MIMO wireless system may include a plurality of the subscriber stations with each subscriber station having a receiver with one active antenna (e.g., the subscriber station 325 of FIG. 3).

In one example, the base station 310 may include two transmit antennas and the subscriber station 320 may include two receive antennas (e.g., the channel matrix H is a 2×2 matrix). Accordingly, two beamformed spatial channels may be formed. The base station 310 may use one or both beamformed spatial channels based on signal quality. For example, if the signal strength of one of the beamformed spatial channels is below a quality threshold for data transmission, the base station 310 may use the other beamformed spatial channel only.

Based on the number of spatial channels, the base station 310 (e.g., via the beamformer 230) may determine a beamforming weight associated with each of the plurality of spatial channels (block 430). Each beamforming weight may correspond to a transmit antenna/spatial channel pair. Based on the plurality of beamforming weights, the base station 310 may transmit one or more data streams and pilots associated with the data streams to the subscriber station 320 (block 440). In one example, the base station 310 may transmit data on a first spatial channel over a particular frequency and the pilot on a second spatial channel over the same frequency to the subscriber station 320 without causing interference.

Alternatively, the base station 310 may transmit one or more data streams and midambles associated with the data streams to the subscriber station 320. The subscriber station 320 may retrieve the data from the base station 310 without explicitly knowing the beamforming matrix V because the data and training symbols may be transmitted via the same beamformed spatial channels. In particular, the base station 310 may not need additional bandwidth to transmit the beamforming matrix V. If the base station 310 includes more transmit antennas than the total number of active spatial channels, the base station 310 may select the spatial channels with the strongest signal strengths to transmit data to the subscriber station 320. Further, the beamformed transmission may provide an “array gain” on the received signals if the base station 310 includes more transmit antennas than the total number of active spatial channels. Thus, channel estimation for beamformed spatial channels may be improved. The methods and apparatus described herein are not limited in this regard.

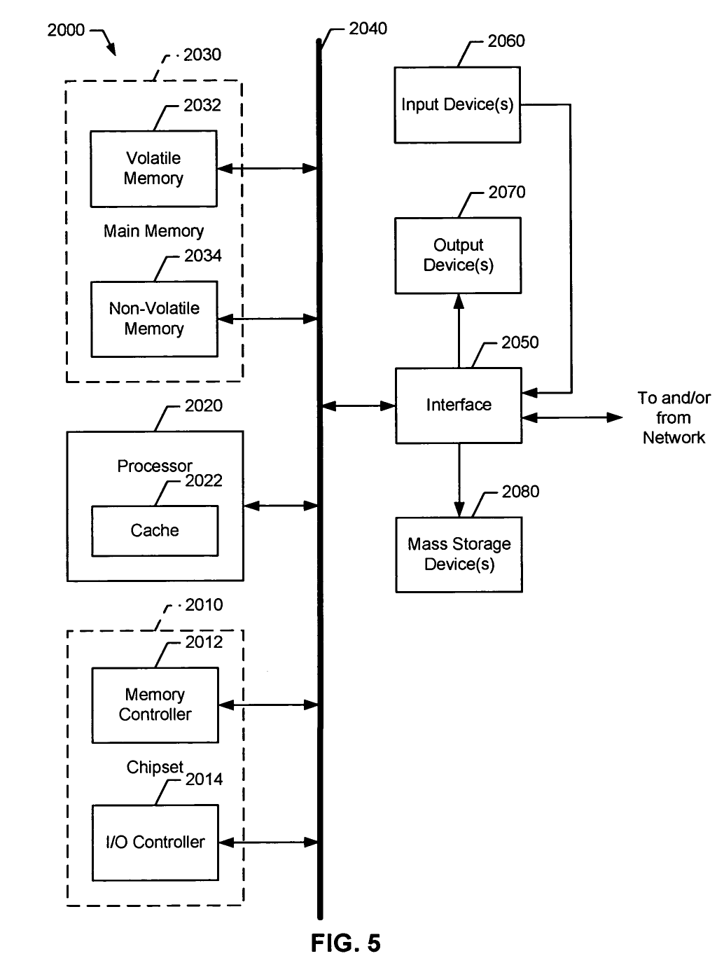

FIG. 5 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 5 includes a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WMAN components, WWAN components, and/or other suitable processing components. For example, the processor 2020 may be implemented using one or more of the Intel® Pentium® technology, the Intele Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 5 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
identifying a plurality of spatial channels;
determining a plurality of beamforming weights, each of the plurality of beamforming weights being associated with one of the plurality of spatial channels;
transmitting a plurality of data streams to two or more subscriber stations simultaneously; and
transmitting a training symbol associated with one of the plurality of data streams based on one of the plurality of beamforming weights.

2. A method as defined in claim 1, wherein identifying the plurality of spatial channels comprises identifying one or more spatial channels based on one or more transmit antennas or receive antennas.

3. A method as defined in claim 1, wherein identifying the plurality of spatial channels comprises identifying a plurality of spatial channels associated with one of a wireless point-to-point multiple-input-multiple-output system or a wireless point-to-multiple-point multiple-input-multiple-output system.

4. A method as defined in claim 1, wherein determining the plurality of beamforming weights comprises determining a plurality of beamforming weights based on a number corresponding to the plurality of spatial channels and a number of antennas at a subscriber station.

5. A method as defined in claim 1, wherein transmitting the training symbol comprises transmitting one of a pilot or a midamble associated with one of the plurality of data streams based on one of the plurality of beamforming weights.

6. A method as defined in claim 1, wherein transmitting the training symbol comprises transmitting a pilot on a first spatial channel and data on a second spatial channel simultaneously, and wherein the first and second spatial channels are associated with the plurality of spatial channels.

7. A method as defined in claim 1, wherein transmitting the training symbol comprises transmitting the training symbol from a base station to a subscriber station.

8. An article of manufacture including content, which when accessed, causes a machine to:
identify a plurality of spatial channels;
determine a plurality of beamforming weights, each of the plurality of beamforming weights being associated with one of the plurality of spatial channels;
transmit a plurality of data streams to two or more subscriber stations simultaneously; and
transmit a training symbol associated with one of the plurality of data streams based on one of the plurality of beamforming weights.

9. An article of manufacture as defined in claim 8, wherein the content, when accessed, causes the machine to identify the plurality of spatial channels by identifying one or more spatial channels based on one or more transmit antennas or receive antennas.

10. An article of manufacture as defined in claim 8, wherein the content, when accessed, causes the machine to determine the plurality of beamforming weights by determining the plurality of beamforming weights based on a number corresponding to the plurality of spatial channels and a number of antennas at a subscriber station.

11. An article of manufacture as defined in claim 8, wherein the content, when accessed, causes the machine to transmit the training symbol by transmitting one of a pilot or a midamble associated with one of the plurality of data streams based on one of the plurality of beamforming weights.

12. An article of manufacture as defined in claim 8, wherein the content, when accessed, causes the machine to transmitting the training symbol by transmitting a pilot on a first spatial channel and data on a second spatial channel simultaneously, and wherein the first and second spatial channels are associated with the plurality of spatial channels.

13. An apparatus comprising:
a plurality of antennas;
a channel identifier to identify a plurality of spatial channels;
a beamformer coupled to the channel identifier to determine a plurality of beamforming weights, each of the plurality of beamforming weights being associated with one of the plurality of spatial channels; and
a plurality of transmitters coupled to the beamformer to transmit a plurality of data streams to two or more subscriber stations simultaneously and to transmit a training symbol associated with one of the plurality of data streams based on one of the plurality of beamforming weights, each of the plurality of transmitters being coupled to one of the plurality of antennas.

14. An apparatus as defined in claim 13, wherein the channel identifier is configured to identify one or more spatial channels based on one or more transmit antennas or receive antennas.

15. An apparatus as defined in claim 13, wherein the beamformer is configured to determine the plurality of beamforming weights based on a number corresponding to the plurality of spatial channels and a number of antennas at a subscriber station.

16. An apparatus as defined in claim 13, wherein the plurality of transmitters is configured to transmit a pilot on a first spatial channel and data on a second spatial channel simultaneously, and wherein the first and second spatial channels are associated with the plurality of spatial channels.

17. An apparatus as defined in claim 13, wherein the training symbol comprises one of a pilot or a midamble.

18. A system comprising:
a flash memory; and
a processor coupled to the flash memory to identify a plurality of spatial channels, to determine a plurality of beamforming weights, and to transmit a plurality of data steams to two or more subscriber stations simultaneously and to transmit a training symbol associated with one of the plurality of data streams based on one of the plurality of beamforming weights, wherein each of the plurality of beamforming weights being associated with one of the plurality of spatial channels.

19. A system as defined in claim 18, wherein the processor is configured to identify one or more spatial channels based on one or more transmit antennas or receive antennas.

20. A system as defined in claim 18, wherein the processor is configured to determine the plurality of beamforming weights based on a number corresponding to the plurality of spatial channels and a number of antennas at a subscriber station.

21. A system as defined in claim 18, wherein the processor is configured to transmit a pilot on a first spatial channel and data on a second spatial channel simultaneously, and wherein the first and second spatial channels are associated with the plurality of spatial channels.

22. A system as defined in claim 18, wherein the training symbol comprises one of a pilot or a midamble.
